(19) United States
(12) Patent Application Publication
(10) Pub. No.: US 2015/0007311 A1
(43) Pub. Date: Jan. 1, 2015

(54) Security Key for a Computing Device

(71) Applicant: International Business Machines Corporation, Armonk, NY (US)

(72) Inventor: Shady Copty, Nazareth (IL)

(21) Appl. No.: 13/932,020

(22) Filed: Jul. 1, 2013

(51) Int. Cl. G06F 21/33

(52) U.S. Cl. CPC G06F 21/33
USPC 726/20

(57) ABSTRACT

Machines, systems and methods for data security on a computing device are provided. In one embodiment, the method comprises a method for securing data stored on a data storage medium, the method comprising: activating a first module to remove a layer of security applied to target data stored on a data storage medium associated with a computing device, in response to detecting presence of a security key within a first range of the computing device, wherein the layer of security prevents access to the target data when the first module is inactive, and deactivating the first module, in response to detecting that the security key is no longer within the first range of the computing device, wherein the layer of security is applied to the target data when the first module is deactivated.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to data security and, more particularly, to a system and method for securing data stored on a computing device.

### BACKGROUND

Computing systems, particularly portable communications devices (e.g., laptop computers, smart phones, tablets, etc.), may contain sensitive or confidential data stored on a data storage medium connected to or embedded in such devices. A common practice for protecting the confidential data from unauthorized use is to lock the device using a personal identification number (PIN) or password. This practice inconveniently requires the entry of the PIN or password every time the device is used. Further, a personally set PIN or password may be jeopardized easily, depending on various factors involving the PIN selection criteria, the strength of the PIN and other vulnerabilities of the device.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Machines, systems and methods for data security on a computing device are provided. In one embodiment, the method comprises a method for securing data stored on a data storage medium, the method comprising: activating a first module to remove a layer of security applied to target data stored on a data storage medium associated with a computing device, in response to detecting presence of a security key within a first range of the computing device, wherein the layer of security prevents access to the target data when the first module is inactive, and deactivating the first module, in response to detecting that the security key is no longer within the first range of the computing device, wherein the layer of security is applied to the target data when the first module is deactivated.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary operational environment for a computing device with protectable data stored thereon, in accordance with one or more embodiments.

FIG. 2 is a flow diagram of an exemplary method for securing data access, in accordance with one embodiment.

FIGS. 3 and 4 are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

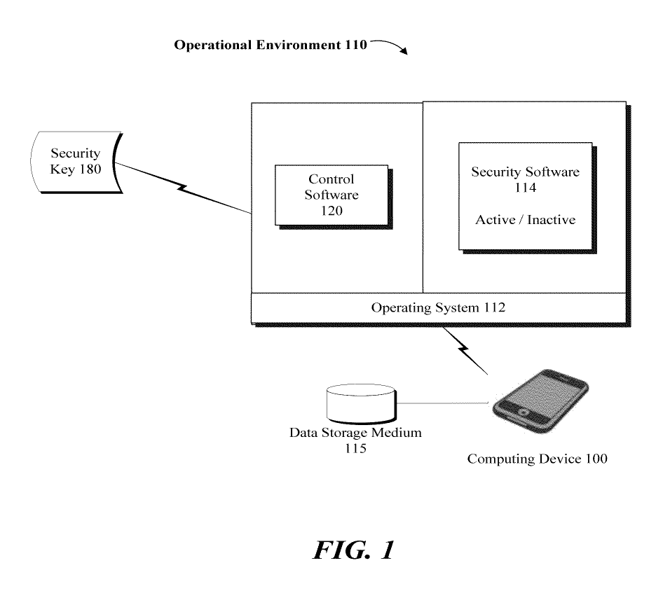

Referring to FIG. 1, an exemplary operational environment 110 is provided, in accordance with one or more embodiments. As shown, a security key 180 may be utilized to store security data (e.g., a PIN, a password, an encryption/decryption key, login ID, etc.). The security data may be used to seek access to secure data stored on a data storage medium 115. The data storage medium 115 (e.g., a memory chip, a hard drive, a solid state device, etc.) may be installed or embedded in a computing device 100 or optionally externally connected to the computing device 100 over a local or remote communications network.

In accordance with one embodiment, security key 180 may communicate with computing device 100 over a communications protocol, such as Bluetooth®, Wifi, WiMax, Near Field Communication (NFC) or other type of wireless communications scheme. Optionally, the communication between security key 180 and computing device 100 may be supported over a wired communication port. In the wireless scenario, when the security key 180 is in a broadcasting mode, the security data stored in security key 180 is broadcasted within a certain distance by way of a transmitter embedded in security key 180. In case of Bluetooth, the range may be as far as 100 meters, for example.

Referring to computing device 100, an operating system 112 may be executed on a processor (not shown) included in computing device 100. Control software 120 and security software 114 may be installed on computing device 100 and executed on top of operating system 112. Security software 114 may be used to prevent unauthorized access to data stored on data storage medium 115. The control software 120 may be executed (optionally as a background application) to determine whether the security key 180 is within the vicinity of computing device 100 and to control switching the security software 114 into a first mode or a second mode.

Depending on implementation, in the first mode (hereafter referred to as the “active mode” by way of non-limiting example), security software 114 is available and enabled to add or remove a layer of security from target data stored on data storage medium 115. Adding a layer of security (e.g., encryption, lock code, password, PIN, etc.) limits access to target data stored on data storage medium 115. When security software 114 is in the active mode, a user using computing device 100 may utilize security software 114 to gain or limit access to data stored on data storage medium 115, by way of for example decrypting or encrypting the target data.

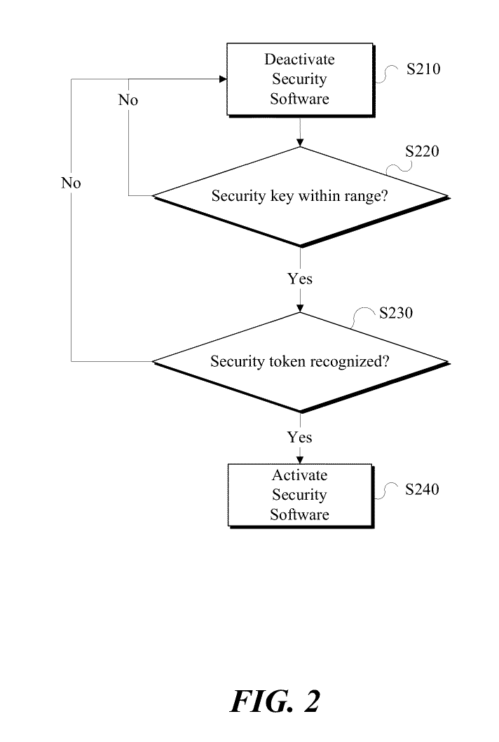

In the second mode (hereafter referred to as the “inactive mode” by way of non-limiting example), security software 114 is not available or enable to add or remove a layer of security from target data stored on data storage medium 115. Accordingly, referring to FIG. 2, if control software 120 does not detect the presence of security key 180 (e.g., due to security key 180 being out of range, corrupted or not in broadcasting mode), then security software 114 either remains in the inactive mode, or if security software 114 was previously in active mode, security software 114 is switched over to inactive mode (S210, S220).

The control software 120 may continue to run (e.g., in the background) and periodically check whether security key 180 is within device 100 detectable range (S220). As noted earlier, security key 180 may broadcast security data (i.e., a token), which may be recognized by control software 120 (S230). In one implementation, if the security token is recognized, control software 120 pairs computing device 100 with security key 180 over, for example, a wireless communication protocol (e.g., Bluetooth, Wifi, WiMax, NFC, etc.).

In accordance with one or more embodiments, when the security token stored on the security key 180 is recognized by the control software 120, control software 120 activates security software 114 by, for example, switching the security software 114 from the inactive mode to the active mode (S240). In one example scenario, when security software 114 is active, security software 114 is capable of decrypting encrypted data on data storage medium 115, otherwise the data remains encrypted, so that the data cannot be accessed by an unauthorized user who does not have the security key 180.

As such, if the security token stored on the security key 180 is not recognized by the control software 120, then the security software 114 remains in the inactive mode and data stored on data storage medium 115 cannot be accessed, until the computing device 100 is in the proper range of a security key 180 that includes an acceptable security token. One or more of the security key 180, the security token, or the control software 120 may be solely instrumented by an authorized person (e.g., an administrator) and may not be updated or modified by the user of the computing device 100. As such, if the security key 180 is lost, the user of the computing device 100 will ask the authorized person to provide a new security key 180 with a new security token and to reprogram the control software 120 to recognize the new security token.

In accordance with one or more embodiment, if the computing device 100 is lost, advantageously, a third party who finds the computing device will not be able to access the data stored on the data storage medium 115 without the security key 180. Depending on implementation, the security key 180 may be also used to limit access to sensitive software (e.g., apps or applications) installed on the computing device 100 or stored on data storage medium 115. Optionally, security key 180 may be used to limit access to the computing device 100 as a whole (e.g., to completely lock the device), or on a selective manner (e.g., limit access to some data or apps, while leaving some freely accessible) when security software 114 is in the active mode.

It is noteworthy that control software 120 or security software 114 may be implemented in hardware, without detracting from the scope of the claimed subject matter. References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

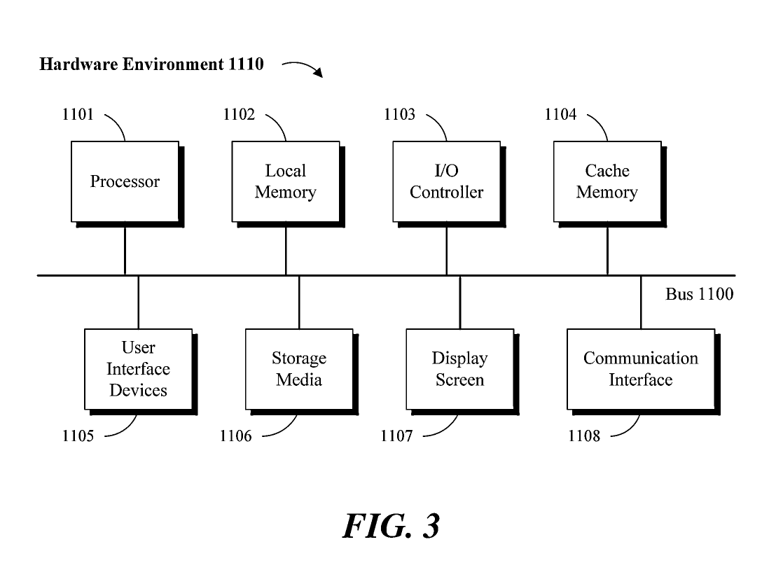

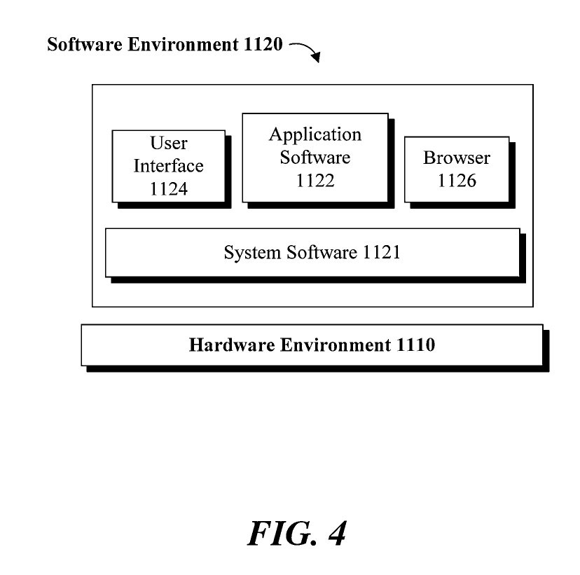

Referring to FIGS. 3 and 4, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for securing data stored on a data storage medium, the method comprising:
activating a first module to remove a layer of security applied to target data stored on a data storage medium associated with a computing device, in response to detecting presence of a security key within a first range of the computing device,
wherein the layer of security prevents access to the target data when the first module is inactive, and
deactivating the first module, in response to detecting that the security key is no longer within the first range of the computing device,
wherein the layer of security is applied to the target data when the first module is deactivated.

2. The method of claim 1, wherein the layer of security is implemented by way of encrypting the target data.

3. The method of claim 1, wherein the layer of security is implemented by way of locking the computing device with a lock code.

4. The method of claim 1, wherein the target data is program code executable on the computing device.

5. The method of claim 1, wherein the security key communicates with the computing device over a wireless communication protocol.

6. The method of claim 5, wherein the wireless communication protocol comprises at least one of Wifi, Bluetooth, Near Field Communication, or WiMax.

7. The method of claim 5, wherein communication between the security key and the computing device is established based on a security token transmitted by the security key and recognizable by a control module on the computing device.

8. The method of claim 7, wherein the control module is programmed by an administrative entity to recognize the security token transmitted by the security key.

9. The method of claim 8, wherein a user of the computing device is unaware of the manner in which the security token is recognized by the control module so that if the security key is unavailable, the administrative entity will issue a new security key with a new security token and will reprogram the control module to recognize the new security token.

10. The method of claim 9, wherein the control module is configured to activate and deactivate the first module based on detecting whether the security key is within the first range.

11. A system for securing data stored on a data storage medium, the system comprising:
a logic unit for activating a first module to remove a layer of security applied to target data stored on a data storage medium associated with a computing device, in response to detecting presence of a security key within a first range of the computing device,
wherein the layer of security prevents access to the target data when the first module is inactive, and
deactivating the first module, in response to detecting that the security key is no longer within the first range of the computing device,
wherein the layer of security is applied to the target data when the first module is deactivated.

12. The system of claim 11, wherein the layer of security is implemented by way of encrypting the target data.

13. The system of claim 11, wherein the layer of security is implemented by way of locking the computing device with a lock code.

14. The system of claim 11, wherein the target data is program code executable on the computing device.

15. The system of claim 11, wherein the security key communicates with the computing device over a wireless communication protocol.

16. A computer program product comprising a computer readable storage medium having a computer readable program, wherein the computer readable program when executed on a computer causes the computer to:
activate a first module to remove a layer of security applied to target data stored on a data storage medium associated with a computing device, in response to detecting presence of a security key within a first range of the computing device,
wherein the layer of security prevents access to the target data when the first module is inactive, and
deactivating the first module, in response to detecting that the security key is no longer within the first range of the computing device,
wherein the layer of security is applied to the target data when the first module is deactivated.

17. The computer program product of claim 16, wherein the layer of security is implemented by way of encrypting the target data.

18. The method of claim 16, wherein the layer of security is implemented by way of locking the computing device with a lock code.

19. The method of claim 16, wherein the target data is program code executable on the computing device.

20. The method of claim 16, wherein the security key communicates with the computing device over a wireless communication protocol.
